(19) United States
(12) Patent Application Publication
(10) Pub. No.: US 2006/0124086 A1
(43) Pub. Date: Jun. 15, 2006

(54) Controlled auto-ignition two-stroke engine

(76) Inventor: Juana Elisabeth Fabrega, Parana (AR)

Correspondence Address: JUANA ELISABETH FABREGA, Av. Almafuerte 592, PARANA, ENTRE RIOS, 3100, AR

(21) Appl. No.: 11/281,162

(22) Filed: Nov. 18, 2005

(30) Foreign Application Priority Data
Nov. 17, 2004 (AR) P 20040104228

(51) Int. Cl. F02B 33/04; F02B 25/00; F02D 13/02

(52) U.S. Cl. 123/73 PP; 123/73 V; 123/65 V; 123/65 PE

(57) ABSTRACT

A controlled auto-ignition or spark ignition two stroke piston engine, fed by homogeneous air-fuel mixture, with crankcase scavenging, in which the amount of air-fuel mixture transferred from the crankcase to the cylinder is not greater than the 50% of the cylinder volume; said engine has reed valves in the transfer ports that connect the crankcase to the cylinder to control the internal dynamics of the air-fuel mixture, limiting the instantaneous maximum flow that is transferred to the cylinder in order to achieve the best stratification level among the air-fuel mixture and the exhaust residual gases, getting this way the thermo chemical activation of part of the fuel contained in the mixture. Said engine also has a rotary valve adjacent to the cylinder exhaust port that rotates in synchronism with the crankshaft, which closes the exhaust port a few degrees after the piston reaches the bottom dead center, thus preventing the leakage of the thermo chemically activated mixture and holding part of the burnt gases inside the cylinder. Then, during the compression stroke, more heat is given to the thermo chemically activated mixture decomposing part of the fuel contained in it into activated radicals which act as igniters when close to the top dead center firing the mixture in a simultaneous and complete way, thus obtaining very low levels of CO, HC and Nox emissions, as well as low fuel and oil consumption.

### TECHNICAL FIELD OF THE INVENTION

It applies to spark ignition two-stroke piston engines having crankcase scavenging and exhaust port/s, and which are fed with air-fuel mixture by carburetors or fuel injectors.

### BACKGROUND OF THE INVENTION

Spark ignited two stroke engines with crankcase scavenging and fed by air-fuel mixture are light weight, simple and inexpensive both to manufacture and to maintain for the user, but have the disadvantages of great fuel consumption and high emissions. When idling, these engines have problems to concentrate the air-fuel mixture near the spark plug thus producing misfiring and consequently getting an unstable combustion. Besides, both idling and at other revolutions and charge conditions, part of the air-fuel mixture is sent from the cylinder to the exhaust system demanding great fuel consumption and producing high levels of hydrocarbon emissions.

### BRIEF DESCRIPTION OF THE INVENTION

The present invention is related to a controlled auto-ignition or spark ignition two-stroke internal combustion piston engine with crankcase scavenging and fed by air-fuel mixture, which has reed valves in the transfer ports that connect the crankcase to the cylinder. It also has a rotary valve that rotates in synchronism with the crankshaft and that is adjacent to the cylinder exhaust port.

The method to operate the described engine consists of the following phases: during the piston downward movement in the expansion stroke, the exhaust port is opened by the piston setting the exhaust advance, the rotary valve adjacent to the exhaust port enables the release of the exhaust gases, and therefore they flow to the exhaust system. As the piston continues its downward movement it opens the intake ports, so the reeds of the reed valves housed in the transfer ports begin to get opened by the pressure created in the crankcase thus allowing the passage of the air-fuel mixture but producing a drecrease of pressure and limiting the instantaneous flow to the cylinder. As a consequence, the thermo chemical activation of part of the fuel contained in the air-fuel mixture is improved since there is a better pressure balance between the exhaust residual gases and the air-fuel mixture.

During the piston upward movement the pressure in the crankcase begins to decrease and the pressure in the cylinder begins to increase because the rotary valve begins to close the exhaust port. By the combination of both actions the reeds in the reed valves begin to get closed, so that when the rotary valve closes the exhaust port, the reeds in the reed valves have already closed, separating the crankcase from the cylinder and beginning the compression stroke. During this stroke the heat necessary to decompose part of the fuel contained in the thermo chemically activated mixture is supplied, generating activated radicals which act as thousands of igniters that fire the mixture in a simultaneous and complete way, regardless of the spark jump.

In this way, very low fuel consumption and emission levels can be achieved, whether hydrocarbons, carbon monoxide or NOx.

### BRIEF DESCRIPTION OF THE DRAWINGS

FIGS. 1, 2, 3, 4, 5 and 6 are cross-sections of a single cylinder (6) controlled auto-ignition or spark ignition two-stroke piston engine with crankcase scavenging and fed by homogeneous air-fuel mixture, which has a reed valve between the carburetor and the crankcase, a rotary valve (2) adjacent to the cylinder (6) exhaust port (3) which rotates in synchronism with the crankshaft at a 1 to 1 transmission ratio and also has reed valves (9) housed in the transfer ports (7) between the cylinder (6) and the crankcase.

FIG. 1 shows the piston (1) in the downward movement during the expansion stroke when it begins to open the exhaust port (3).

FIG. 2 shows the piston (1) in the downward movement before reaching the bottom dead center, where the air-fuel mixture is pushed from the crankcase to the cylinder (6) going through the reed valves (9) whose reeds (5) are opened.

FIG. 3 is the same view as the one illustrated in FIG. 2 but it has been rotated 90 degrees.

FIG. 4 shows the piston (1) a few degrees after the beginning of the upward movement where the rotary valve (2) has begun to close the exhaust port (3) and where the reeds (5) in the reed valves (9) have also begun to get closed.

FIG. 5 shows the piston (1) in the upward movement where the reeds (5) in the reed valves (9) and the rotary valve (2) are closed.

FIG. 6 is the same view as the one illustrated in FIG. 5 but it has been rotated 90 degrees.

FIG. 7 is a cross-section of the same engine illustrated in FIGS. 1 to 6, which uses homogeneous mixture and also has a fuel injector (12) housed in the cylinder over head.

FIG. 8 is a cross-section of a single cylinder (6) controlled auto-ignition or spark ignition two-stroke piston (1) engine, with crankcase scavenging and fed by homogeneous air-fuel mixture; it has a plate shaped rotary valve (10) that is adjacent to the cylinder (6) exhaust port (3) and rotates in synchronism with the crankshaft (11); it also has reed valves (9) housed in the transfer ports (7) between the cylinder (6) and the crankcase.

FIG. 9 is a lengthwise cross-section of the rotary valve (10) corresponding to the same engine as in FIG. 8.

FIG. 10 is a cross-section of the exhaust system that is used in this type of engines, which has an inlet pipe (15), an outlet pipe (22), an expansion chamber (17) and another low pressure chamber (21) connected by a hole (16) and by reed valves (19), which have reeds (20).

FIG. 11 is a cross-section showing the engine and the exhaust system in which the piston (1) is shown in the downward movement when beginning to open the exhaust port (3).

FIG. 12 is a cross-section showing the engine and the exhaust system in which the piston (1) is shown in the downward movement when it is about to open the intake ports (4).

### DETAILED DESCRIPTION OF THE INVENTION

To exemplify the invention, it will be used an alternate single cylinder (6) controlled auto-ignition or spark ignition two-stroke engine with crankcase scavenging, low compression ratio, fed by a carburetor with homogeneous air-fuel mixture. Said engine has a reed valve between the carburetor and the crankcase, a rotary valve (2) adjacent to the cylinder (6) exhaust port (3) which rotates in the same direction that the crankshaft (clockwise) at a 1 to 1 transmission ratio and also has reed valves (9) in the transfer ports (7).

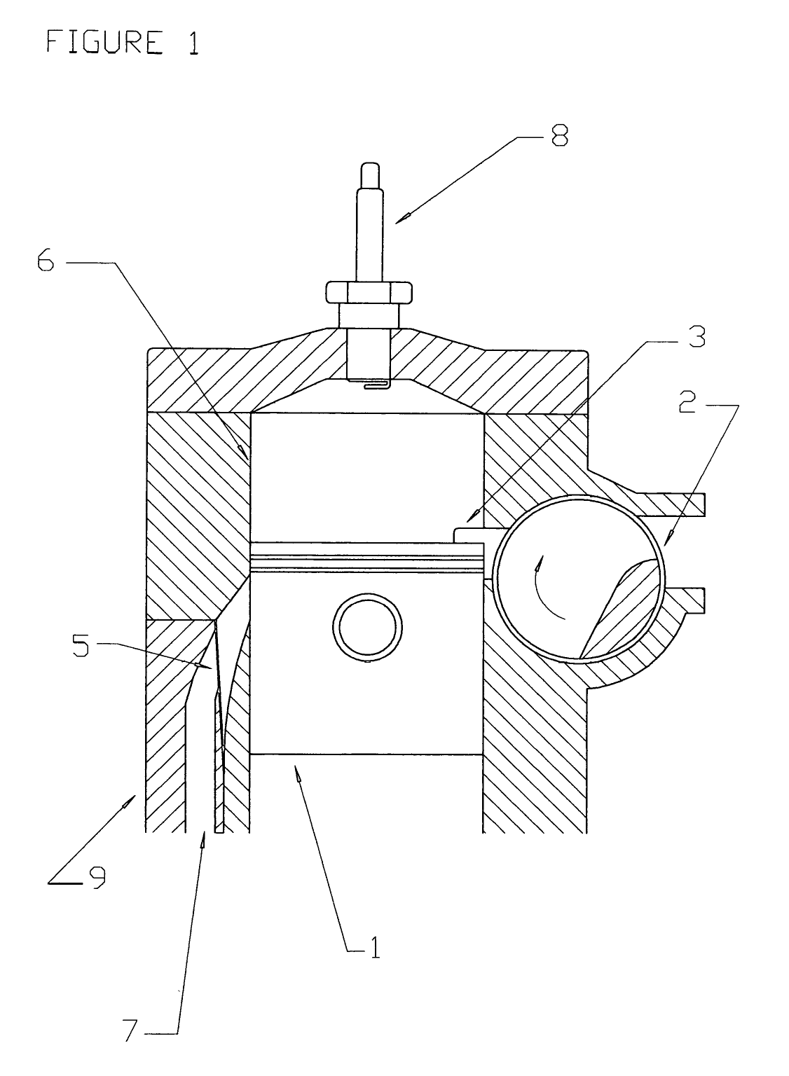

During the downward movement of the piston (1) in the expansion stroke, it opens the exhaust port (3) setting the exhaust advance and starting the release of the exhaust gases to the exhaust system since the rotary valve (2) enables the passage of the exhaust gases, as shown in FIG. 1.

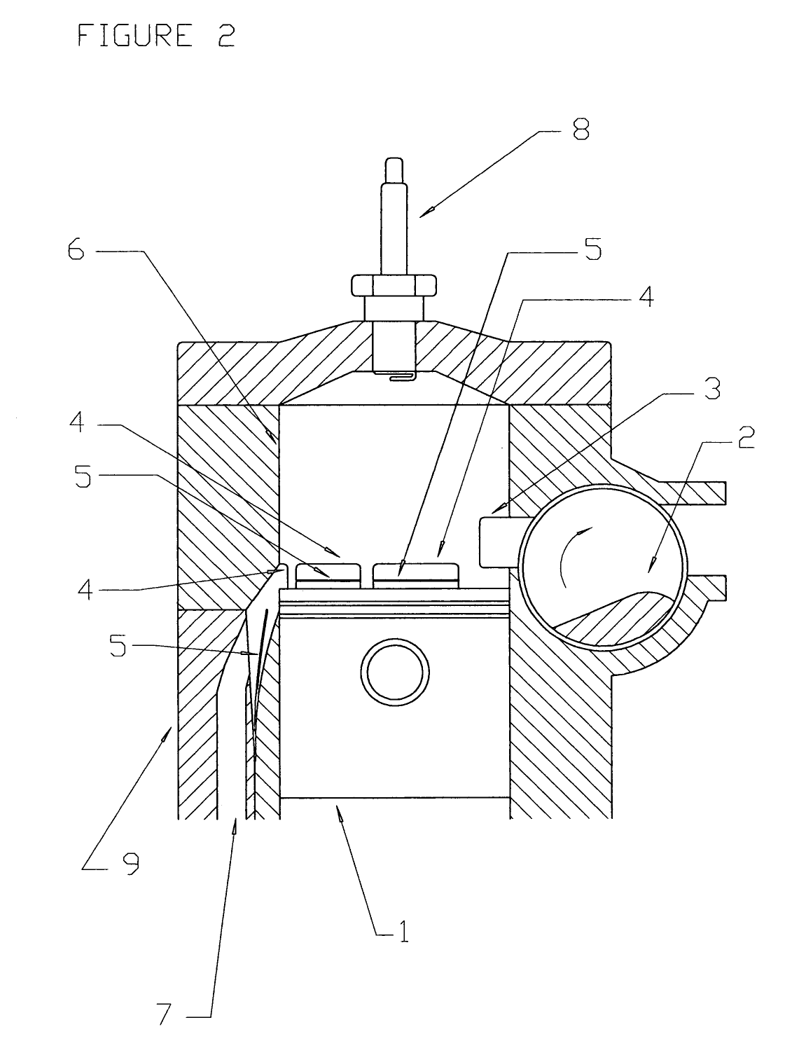

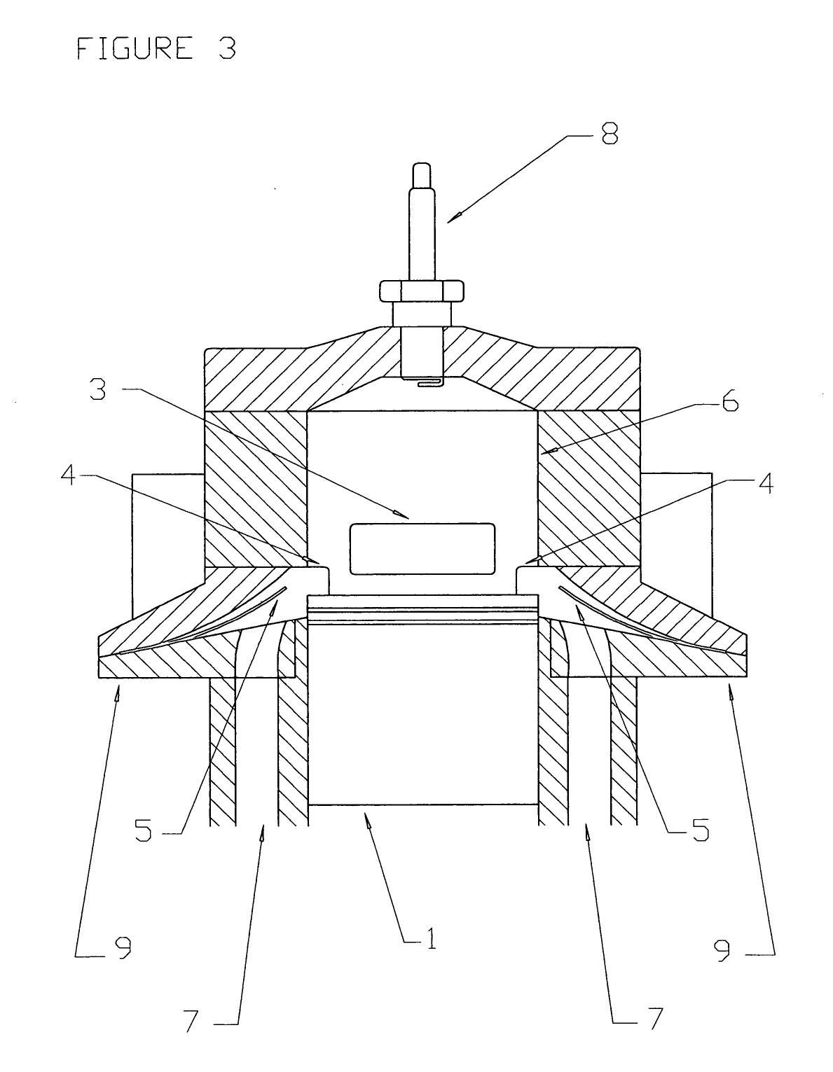

Going on with its downward movement, the piston (1) opens the intake ports (4), as shown in FIGS. 2 and 3, due to the pressure generated in the crankcase by the piston (1) downward movement the reeds (5) in the reed valves (9) begin to open enabling the passage of the air-fuel mixture to the cylinder (6), said reed valves (9) control the internal dynamics of the fluid (mixture), getting a more continuous flow from the crankcase to the cylinder (6), thus minimizing the mixture among the fresh gases and the exhaust residual gases, therefore the interchange of the necessary heat to achieve the thermo chemical activation of part of the fuel contained in the air-fuel mixture is achieved in the border area of both fluids.

Said reed valves (9) also reduce the pressure peaks generated in the crankcase and avoid the withdrawal of the air-fuel mixture to the crankcase.

The control of the air-fuel mixture flow to the cylinder (6) is very important because if the mass transferred per unit of time is too high, both fluids tend to mix up thus reducing the thermal capability of the exhaust residual gases without getting the thermo chemical activation of the fuel contained in the mixture.

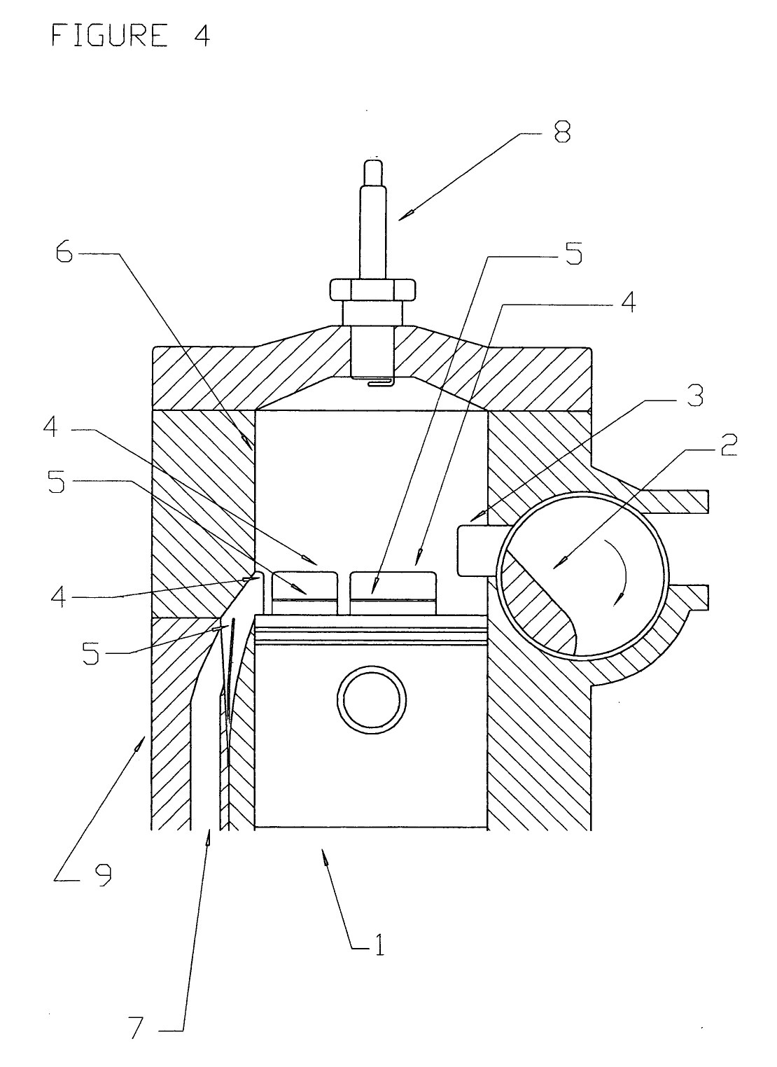

During the upward movement of the piston (1), the pressure in the crankcase begins to decrease and the pressure in the cylinder (6) begins to increase because the rotary valve (2) begins to close the exhaust port (3). By the combination of both actions the reeds (5) in the reed valves (9) begin to close, as shown in FIG. 4.

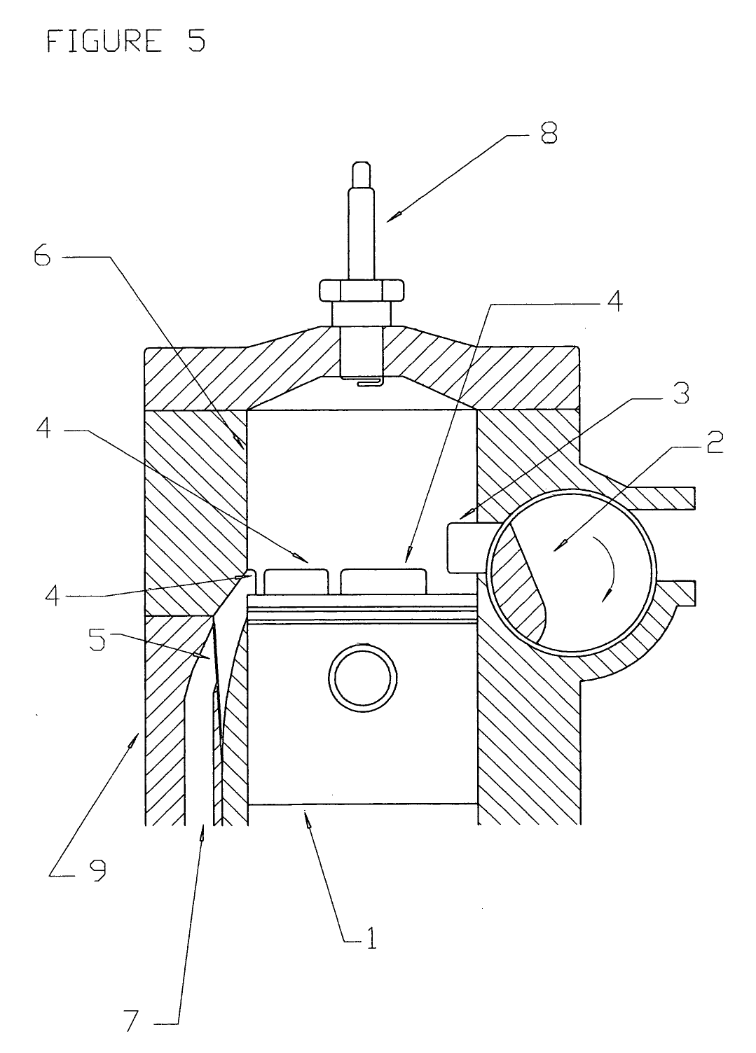

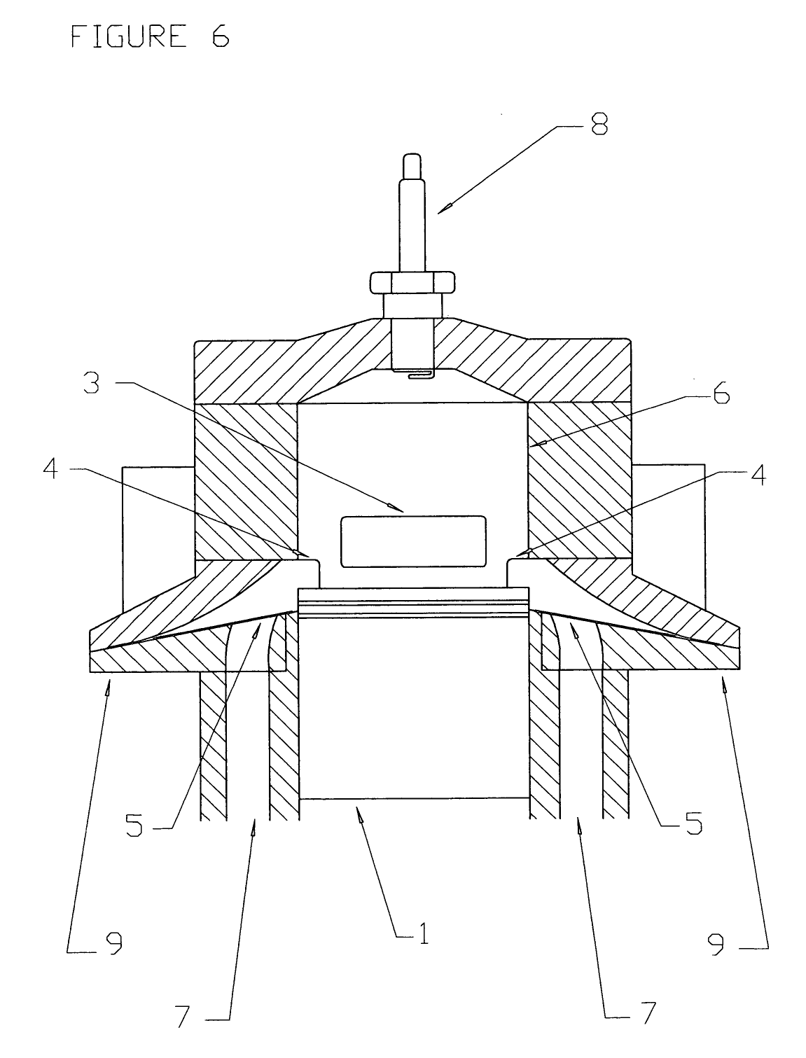

By the time the rotary valve (2) closes the exhaust port (3), the reeds (5) in the reed valves (9) have already closed, thus preventing the thermo chemically activated air-fuel mixture from reentering the crankcase, as shown in FIGS. 5 and 6.

The closure of the rotary valve (2) is achieved at approx. 40 degrees after the bottom dead center, before the piston (1) closes the intake ports (4). This way, the amount of burnt gases that remain in the cylinder (6) is controlled, the amount of air-fuel mixture that enters the cylinder (6) is limited and the thermo chemically activated mixture is prevented from being pushed from the cylinder (6).

When the piston (1) continues its upward movement, the intake of air-fuel mixture that enters the crankcase begins, and the compression stroke of the thermo chemically activated mixture which receives the heat generated during said compression also begins. Due to this supply of heat and to the heat received while entering the cylinder (6), part of this fuel is decomposed into activated radicals such as CH, H, OOH, C2, CHO, which act as igniters firing the mixture when they are close to the top dead center, getting a simultaneous and complete combustion as a result.

The reed valves (9) prevent that sudden changes of pressure in the crankcase generated by changes in the position of the throttle control get directly to the cylinder (6) thus enabling a smooth increase of the mixture transference keeping the heat interchange capability among the exhaust residual gases and the air-fuel mixture. This way, the combustion keeps being auto-ignited whether accelerating or decelerating by means of sudden changes in the throttle control position.

The passage of mixture from the crankcase to the cylinder (6) is 50% of the cylinder (6) volume at the most; if more air-fuel mixture was transferred, the activation of part of the fuel contained in the mixture would be harder to achieve since the stratification level between the exhaust residual gases and the air-fuel mixture is lost. Besides, this way a residual percentage of burnt gases is assured to prevent the formation of Nox during the combustion.

As explained in the preceding paragraphs, the intake stroke of fresh mixture in the crankcase begins when the reeds (5) in the reed valves (9) get closed, this is beneficial because the closer to the bottom dead center the intake begins, the smoother and more continuous the intake will develop, also increasing the amount of degrees during which it takes place. Because of this and because the mixture flow circulating in the engine is low, the usage of carburetors with small diffusers is possible, since they enable a better fuel emulsion and a better control of the flow.

When the mixture mass to be transferred to the cylinder (6) is very small, the reeds (5) in the reed valves (9) get closed before the rotary valve (2) closes the exhaust port (3) and when the mixture mass to be transferred to the cylinder (6) is close to the 50% of the cylinder (6) volume, the reeds (5) get closed by the joint action of the increase of pressure in the cylinder (6) produced by the rotary valve (2) closure and the decrease of pressure in the crankcase generated by the piston (1) upward movement. From this explanation it could be seen that the end of the mixture intake to the cylinder (6), that is, the scavenging delay, is variable according to the mixture mass to be transferred, being the upper limit the point in which the rotary valve (2) closes the exhaust port (3).

As explained in the preceding paragraphs, in order to achieve the mixture auto-ignition it is necessary that it gets two supplies of heat: being the mass of residual burnt gases the first one and the compression of mixture during the compression stroke, the second.

These supplies of heat are variable according to the engine revolutions per minute and to the engine charge. Therefore, it becomes necessary to adjust the air/fuel ratio in order to control the air-fuel mixture auto-ignition advance.

If the engine operates in auto-ignition at a certain number of revolutions per minute and charge, with such an air-fuel mixture ratio that enable the auto-ignition to begin close to the top dead center and reach the maximum combustion pressure after the top dead center, the optimum operating level is achieved; but if the engine charge is increased the first supply of heat as well as the second get increased, thus making the auto-ignition to begin earlier and develop rapidly reaching the maximum combustion pressure before reaching the top dead center. As it could be seen, this is an unwanted situation which is very unfavorable to the engine, therefore the air-fuel mixture ratio is corrected in this case enriching it so that, by having a greater amount of fuel, it could be able to absorb the exceeding heat available under this engine charge condition, thus making it possible to delay the mixture auto-ignition advance to the previous value and to increase the maximum combustion pressure value, but after reaching the top dead center.

Therefore, by means of a small adjustment of the air-fuel ratio, the mixture auto ignition can be controlled, the moment it begins, how it develops and the output power.

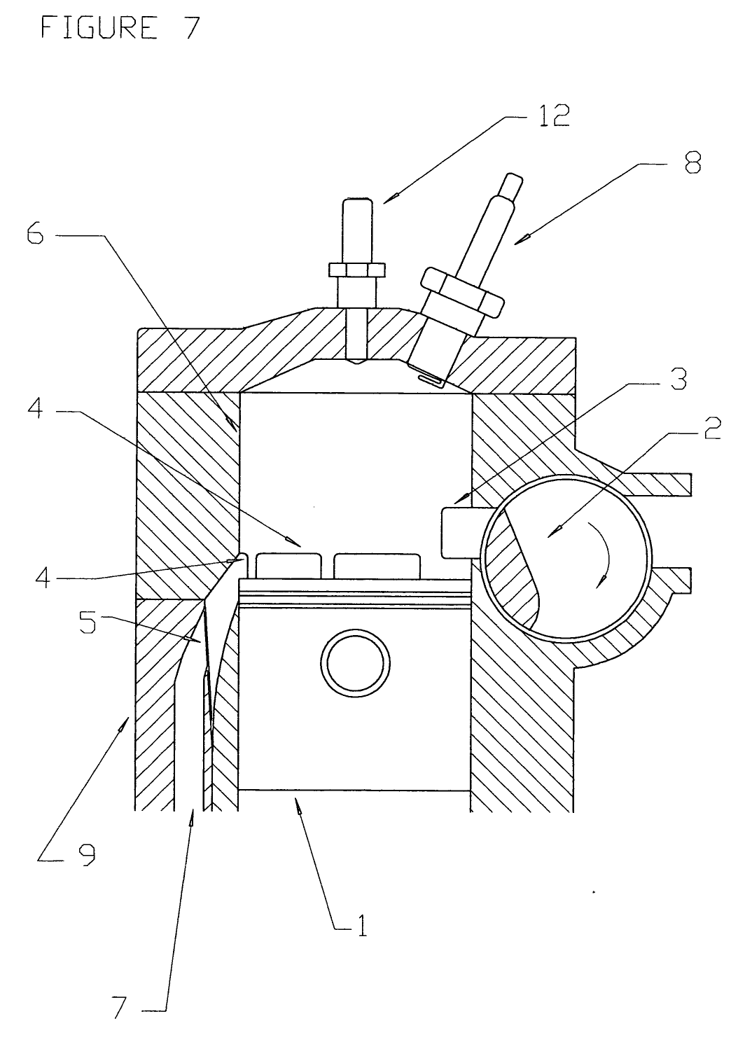

Another option to control the air-fuel ratio is shown in FIG.7, in which it could be seen that the engine is still fed by homogeneous mixture coming form the crankcase but it also has a fuel injector (12) that is responsible for injecting a small amount of fuel once the rotary valve (2) has closed the exhaust port (3). The amount to be injected is approximately the 35% of the total necessary fuel and it is used to control the auto-ignition advance and the engine output power.

The fuel injector (12) does not operate permanently, because when the engine charge is low it does not inject and the engine is fed only with the mixture coming from the crankcase, but as the engine charge is increased, the fuel injector (12) begins to inject more fuel until reaching approximately the 35% of the total fuel in the cylinder (6), when the engine operates at full charge.

The higher the octane number in the fuel, the longer the period of time during which the combustion will take place, getting as a result that the maximum pressure generated during the combustion be further from the top dead center, therefore the mixture auto ignition is easier to control using fuel with high octane number.

As regards the closure position of the rotary valve (2), it has been tested in prototype engines closing in different positions and the results show that the amount of residual exhaust gases can be effectively controlled, as well as the leakage of mixture to the exhaust. The best results have been achieved when the rotary valve (2) closes in the area between the 30 and 50 degrees after the bottom dead center.

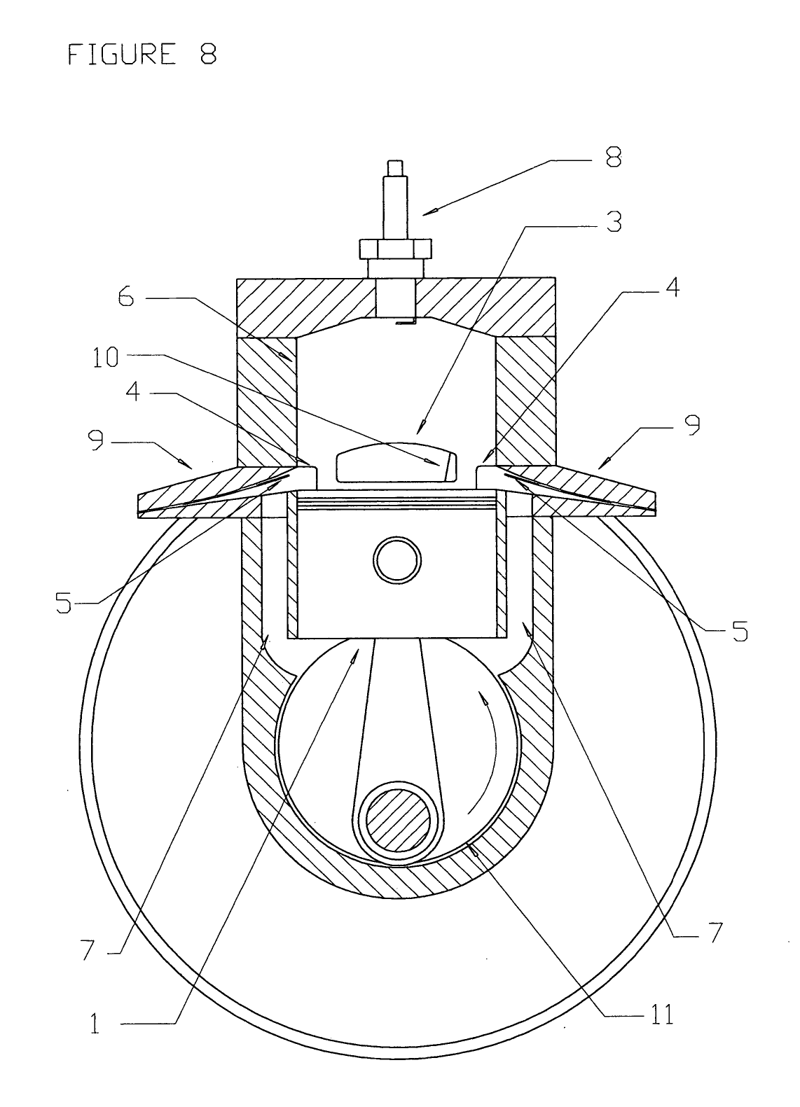

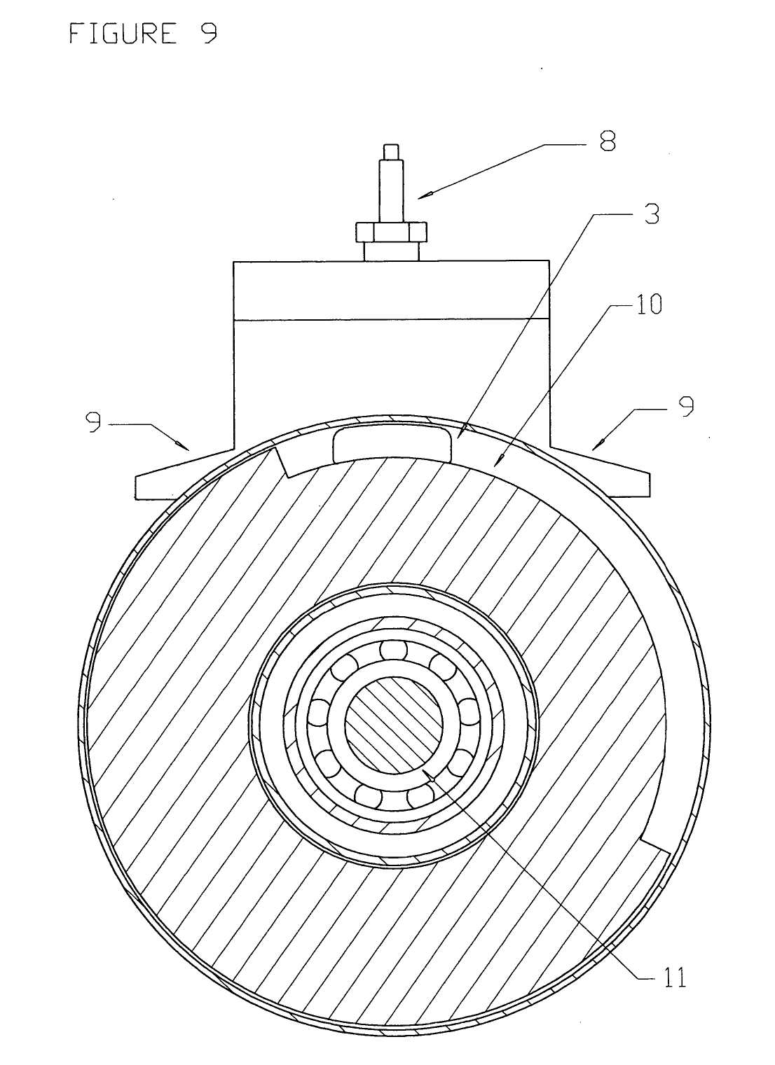

FIGS. 8 and 9 show another engine design option, in which a plate shaped rotary valve (10) is used, that rotates in synchronism with the crankshaft (11), it is very simple since it does not have drives, and the function is the same: to close the exhaust port (3) during the upward movement of the piston (1) a few degrees after it surpasses the bottom dead center and before it closes the intake ports (4). As it can be seen, the exhaust outlet is lateral, which makes it very suitable for outboard engines. This design is also very suitable for small engines like the ones used for lawn and garden equipment, the so called “powertools”, and also for model planes, etc.

It should be mentioned also that this rotary valve (10) has a closure speed much higher than the rotary valve (2) shown in FIGS. 1, 2, 3, 4, 5, 6 and 7 because its diameter is greater.

Both (2) and (10) rotary valve designs could be manufactured with variable closure; this option has not been tested because good results have been sought by the use of valves of fixed closure because they are very simple and very good results can be obtained as regards emissions and fuel consumption, without the need of variable closure valves. As it has been explained, the variable parameter used is the air-fuel ratio; it enables the control of the auto-ignition and at the same time advances it or delays it according to the engine charge and revolutions per minute.

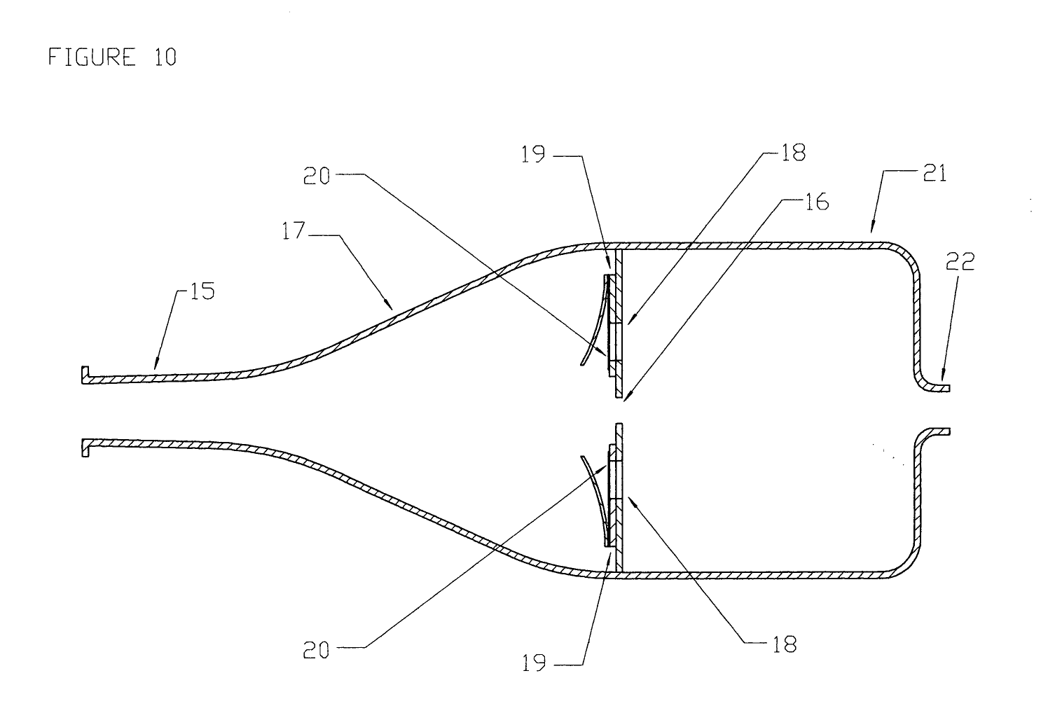

As regards the reed valves (9), their shape can vary a lot, but in the case of the engines used as example the volume existing between the cylinder (6) and the reed valves (9) was intended to be as small as possible because this way the cylinder (6) can hold more charge every cycle. FIG. 10 outlines the exhaust system used in this engine, in which it can be seen that it has an inlet pipe (15), an expansion chamber (17), a low pressure chamber (21), an outlet pipe (22), both chambers are connected by a hole (16) and by one or more reed valves (19).

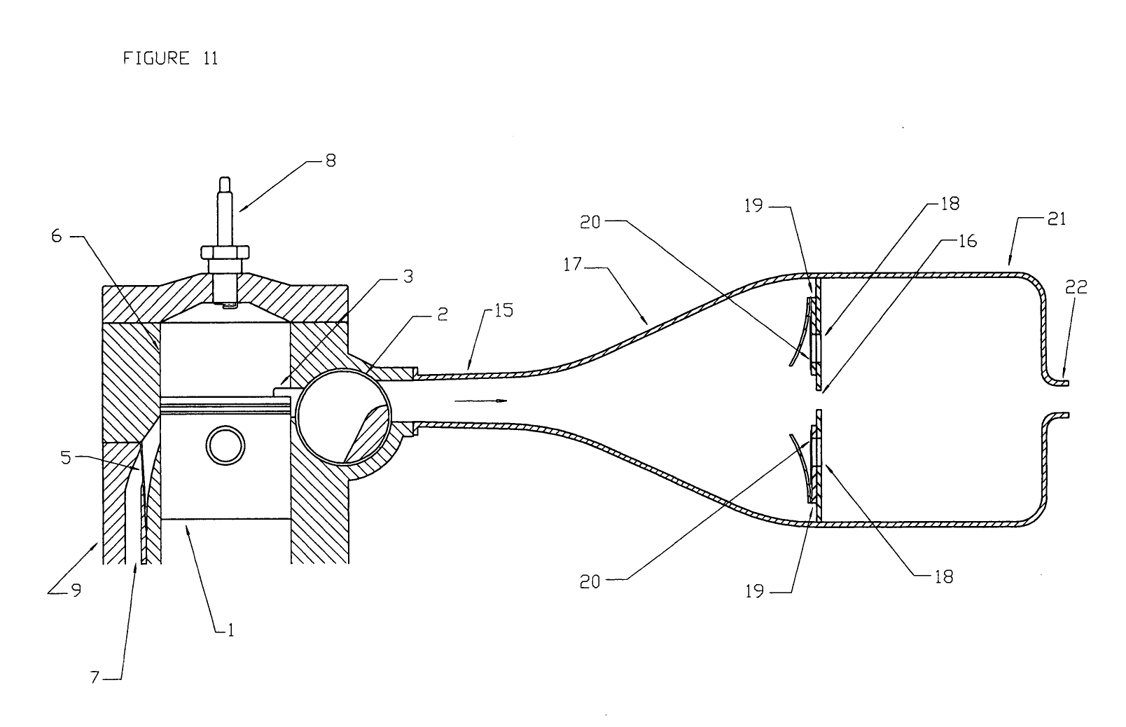

Analyzing the exhaust system when the engine operates at full charge and maximum revolutions per minute, it can be seen that the piston (1) during the expansion stroke opens the exhaust port (3) thus starting the release of the exhaust gases, which begin to flow through the inlet pipe (15) towards the expansion chamber (17) as shown in FIG. 11. Then, said exhaust gases begin to flow towards the low pressure chamber (21) through the hole (16) that connects both chambers, being this hole the only link between both chambers because the reeds (20) in the reed valves (19) remain closed due to the difference of pressure existing in both chambers. Once the exhaust gases are in the low pressure chamber (21), they are pushed to the atmosphere through the outlet pipe (22).

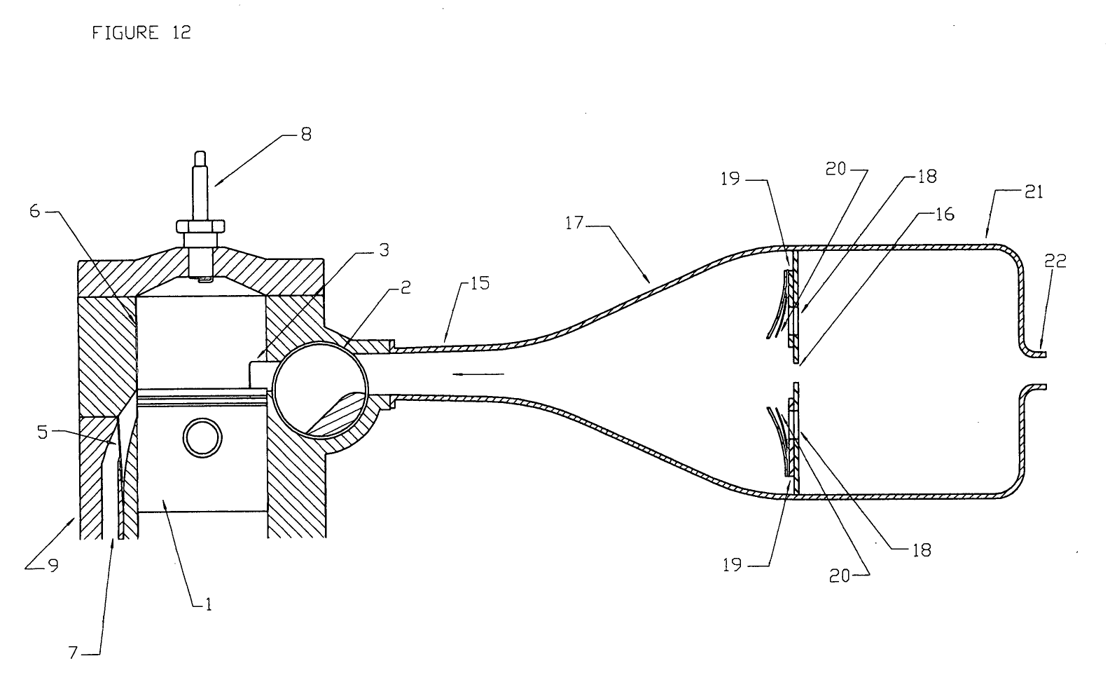

Analyzing now the engine when operates under less charge, as shown in FIG. 11, it can be seen that the piston (1) in the downward movement during the expansion stroke opens the exhaust port (3) starting the release of the exhaust gases, which begin to flow to the exhaust system, but since the exhaust gases mass to be withdrawn from the cylinder (6) is small, a rapid drecrease of pressure in the cylinder (6) is produced, and as the piston (1) is developing the downward movement without opening the intake ports (4), it produces an additional decrease of pressure making the exhaust gases to be stopped or drawn back to the cylinder (6). It is at this point where the reeds (20) in the reed valves (19) open the holes (18) allowing the passage of the exhaust gases from the low pressure chamber (21) to the expansion chamber (17), as shown in FIG. 12.

By enlarging the passage area between the chambers as explained in the preceding paragraph, the drecrease of pressure generated by the piston (1) is reduced, so the fluid is moved towards the cylinder (6) more easily, thus reaching the cylinder (6) faster.

When the piston (1) continues the downward movement it opens the intake ports (4) allowing the entrance of fresh mixture to the cylinder (6), but this mixture flow will not be able to exit the cylinder (6) because it meets the exhaust gases that are trying to enter the cylinder (6) through the exhaust port (3), therefore, the exhaust gases kinetic energy is used to prevent the air-fuel mixture from leaking to the exhaust.

The exhaust is restrictive to engines operating at full charge and maximum revolutions per minute because the hole (16) located between both chambers limits the maximum flow of exhaust gases that are released from the engine and behaves as variable exhaust under partial charge conditions of the engine since it enlarges the passage area between both chambers but only to facilitate the drawing back of the exhaust gases to the cylinder (6) keeping the capability of being restrictive limiting the amount of exhaust gases that is released from the engine.

As it can be seen, this engine has component and control parts that are both very simple and inexpensive, which enable the auto-ignition combustion to be developed uninterrupted, except when the engine is idling in which case a spark jump becomes necessary. Emissions of HC, Nox and CO are very low as well as fuel and oil consumption.

Having described and determined the nature and scope of this invention, and the way it should be implemented, what I claim as my invention is:

1. A controlled auto-ignition or spark ignition two-stroke piston engine, having a reed valve between the crankcase and the carburetor, fed with homogeneous mixture, by means of carburetor or fuel injector, with crankcase scavenging, in which the air-fuel mixture transferred from the crankcase to the cylinder during the scavenging stroke is 50% maximum of the cylinder volume, characterized by having at least one reed valve in each one of the transfer ports that connect the crankcase to the cylinder and a rotary valve that rotates in synchronism with the crankshaft at a 1 to 1 ratio, or integral to it, which is adjacent to the cylinder exhaust port/s and closes said port/s during the upward movement of the piston a few degrees after it reaches the bottom dead center and before it closes the intake ports.

2. A two stroke piston engine as in claim 1, that operates following these phases:
a. In the downward movement during the expansion stroke, the piston opens the exhaust port thus setting the exhaust opening advance. The exhaust gases begin to flow to the exhaust system through the rotary valve which enables their passage.
b. As the piston continues its downward movement, it begins to open the intake ports, and since the reed valves placed in the transfer ports limit the scavenging mixture pressure and flow that enters the cylinder, the interchange of heat is optimized in the border area created between the air-fuel mixture and the exhaust residual gases, getting the thermo chemical activation of part of the fuel contained in the mixture.
c. A few degrees after the piston reaches the bottom dead center during the upward movement and before it closes the intake ports, the rotary valve closes the exhaust port thus preventing the leakage of the thermo chemically activated mixture, holding part of the burnt gases inside the cylinder and, at the same time, making the pressure inside the cylinder rise. Because of this and the drecrease of pressure in the crankcase generated by the upward movement of the piston, the reeds in the reed valves close the transfer ports preventing the thermo chemically activated mixture from drawing back to the crankcase. This way, the compression stroke of thermo chemically activated mixture and exhaust residual gases in the cylinder and the intake stroke of fresh mixture into the crankcase begin.
d. When continuing the upward movement, the piston compresses thermo chemically activated air-fuel mixture supplying more heat to it, so that if said mixture has the correct air-fuel ratio when close to the top dead center, part of the fuel contained in it is decomposed into chemically activated radicals, which act as igniters that fire the mixture in a simultaneous and complete way, regardless of the spark jump.

3. A two stroke piston engine as in claims I and 2, characterized by having any mechanism as long as it modifies the homogeneous mixture air/gasoline ratio, enriching it or making it poorer according to the changes in the engine charge and revolutions per minute conditions in order to control the engine power output and the moment in which the mixture auto-ignition begins during the compression stroke, advancing or delaying it in relationship to the top dead center.

4. A two stroke piston engine as in claims 1 and 2, characterized by being fed with homogeneous mixture and by having a fuel injector placed in the cylinder over head to inject 35% maximum of the total fuel that enters the cylinder, the fuel is injected after the rotary valve has closed the exhaust port, said amount of fuel injected by the fuel injector is used to control the engine power output as well as the moment in which the mixture auto-ignition begins during the compression stroke, and the way the combustion is developed, following the changes in the engine charge and revolutions per minute conditions.

5. A control system of the fluid internal dynamics for auto-ignition or spark ignition two stroke piston engines, with crankcase scavenging, having al least one exhaust port and at least one transfer port between the crankcase and the cylinder, characterized by having at least one reed valve in the transfer ports between the intake port/s and the crankcase to control the flow and pressure among them and to prevent the fluid from being drawn back to the crankcase.

6. A control system of the fluid internal dynamics as in claim 5, in which the reed valve/s can be placed anywhere between the intake port/s and the crankcase.

7. A control system of the internal movement of the fluid as in claim 5, having the characteristic that it can be used in two stroke engines without exhaust valve or with exhaust valve of any type and shape.

8. A control system of the fluid internal dynamics as in claim 5, having the characteristic that each one of the reed valves can have one or more reeds.

9. A two stroke piston engine as in claim 1, having the characteristic that the rotary valve can be a plate connected to the crankshaft or a cylindrical valve to which a portion has been taken out, as illustrated in the figures.

10. An exhaust system for controlled auto-ignition or spark ignition two stroke piston engines, which are fed by homogeneous mixture and have crankcase scavenging and exhaust port/s, with the characteristic of having two chambers connected by a hole and by reed valves which are moved by the difference of pressure among both chambers, which enable the fluid to flow in only one way, being this towards the cylinder this way enlarging the exhaust gases passage area to the cylinder making their withdrawal to be easier to achieve.
